(19) United States
(12) Patent Application Publication
(10) Pub. No.: US 2025/0052980 A1
(43) Pub. Date: Feb. 13, 2025

(54) Lens Assembly

(71) Applicants: Sintai Optical (Shenzhen) Co., Ltd., ShenZhen City, Guandong Province (CN); Asia Optical Co., Inc., Taichung (TW)

(72) Inventor: Jian-Sin Chen, Taichung (TW)

(21) Appl. No.: 18/766,749

(22) Filed: Jul. 9, 2024

(30) Foreign Application Priority Data
Aug. 9, 2023 (CN) 202310999737.8

(51) Int. Cl. G02B 9/14

(52) U.S. Cl. CPC G02B 9/14

(57) ABSTRACT

A lens assembly includes a first lens group, a second lens group, and a third lens group, all of which are arranged in order from an object side to an image side along an optical axis. The first lens group is with positive refractive power. The second lens group is with negative refractive power and includes at least two lenses. The third lens group is with positive refractive power and includes a 3-1 lens, a 3-2 lens, a 3-3 lens, and a 3-4 lens. Three lens groups are with refractive power. The 3-1 lens is a biconvex lens with positive refractive power and includes a convex surface facing the object side and another convex surface facing the image side. The 3-3 lens includes a concave surface facing the image side. Two lenses closest to the image side are meniscus lenses among the second lens group and the third lens group.

### BACKGROUND OF THE INVENTION

### Field of the Invention

The present invention relates to a lens assembly.

### Description of the Related Art

Today's high resolution lens assembly often has longer total lens length and larger volume which is no longer able to meet the application needs for today's unmanned aerial vehicle. Therefore, the lens assembly needs a new structure in order to meet the requirements of miniaturization and high resolution at the same time for unmanned aerial vehicle.

### BRIEF SUMMARY OF THE INVENTION

The invention provides a lens assembly to solve the above problems. The lens assembly of the invention is provided with characteristics of a decreased total lens length, an increased resolution, and still has a good optical performance.

The lens assembly in accordance with an exemplary embodiment of the invention includes a first lens group, a second lens group, and a third lens group, all of which are arranged in order from an object side to an image side along an optical axis. The lens groups of the lens assembly that are with refractive power are three in number. The first lens group is with positive refractive power. The second lens group is with negative refractive power and includes at least two lenses. The third lens group is with positive refractive power and includes a 3-1 lens, a 3-2 lens, a 3-3 lens, and a 3-4 lens, all of which are arranged in order from the object side to the image side along the optical axis. The 3-1 lens is a biconvex lens with positive refractive power and includes a convex surface facing the object side and another convex surface facing the image side. The 3-3 lens includes a concave surface facing the image side. Two lenses closest to the image side are meniscus lenses among the second lens group and/or the third lens group.

In another exemplary embodiment, the refractive powers of adjacent lenses in the second lens group or the third lens group are opposite.

The lens assembly in accordance with another exemplary embodiment of the invention includes a first lens group, a second lens group, and a third lens group, all of which are arranged in order from an object side to an image side along an optical axis. The lens groups of the lens assembly that are with refractive power are three in number. The first lens group is with positive refractive power. The second lens group is with negative refractive power. The third lens group is with positive refractive power. A lens closest to the object side in the third lens group is a biconvex lens with positive refractive power and includes a convex surface facing the object side and another convex surface facing the image side. The second lens group or the third lens group includes a plurality of lenses and adjacent lenses among the lenses have opposite refractive powers.

In another exemplary embodiment, the third lens group includes a 3-1 lens, a 3-2 lens, a 3-3 lens, and a 3-4 lens, all of which are arranged in order from the object side to the image side along the optical axis, the 3-3 lens includes a concave surface facing the image side, and two lenses closest to the image side in the second lens group and/or the third lens group are meniscus lenses.

In yet another exemplary embodiment, the second lens group includes a 2-1 lens, a 2-2 lens, and a 2-3 lens, one of the 2-1 lens, the 2-2 lens, and the 2-3 lens is a biconcave lens and the other two are meniscus lenses, the 2-1 lens and the 2-3 lens have the same refractive powers and the 2-1 lens and the 2-2 lens have opposite refractive powers, and a lens closest to the object side in the second lens group and a lens closest to the object side in the third lens group have opposite refractive powers.

In another exemplary embodiment, an object side surface shape of a lens closest to the object side in the second lens group is the same as its image side surface shape, image side surface shapes of adjacent lenses in the first lens group or the second lens group are the same, and the second lens group and the third lens group includes a total of five meniscus lenses.

In yet another exemplary embodiment, the first lens group includes a 1-1 lens, a 1-2 lens, and a 1-3 lens, all of which are arranged in order from the object side to the image side along the optical axis, the second lens group includes a 2-1 lens, a 2-2 lens, and a 2-3 lens, all of which are arranged in order from the object side to the image side along the optical axis, the 1-2 lens includes a concave surface facing the image side, the 2-1 lens includes a concave surface facing the object side, the 2-2 lens is a meniscus lens with positive refractive power and includes a convex surface facing the object side and a concave surface facing the image side, and the 2-3 lens is a meniscus lens with negative refractive power and includes a convex surface facing the object side and a concave surface facing the image side.

In another exemplary embodiment, the 1-1 lens is a meniscus lens with negative refractive power and includes a convex surface facing the object side and a concave surface facing the image side, the 1-2 lens is a meniscus lens with positive refractive power and further includes a convex surface facing the object side, the 1-3 lens is a meniscus lens with positive refractive power and includes a convex surface facing the object side and a concave surface facing the image side, the 2-1 lens is a biconcave lens with negative refractive power and further includes another concave surface facing the image side, the 3-2 lens is a meniscus lens with negative refractive power and includes a convex surface facing the object side and a concave surface facing the image side, the 3-3 lens is a meniscus lens with positive refractive power and further includes a convex surface facing the object side, and the 3-4 lens is a meniscus lens with negative refractive power and includes a concave surface facing the object side and a convex surface facing the image side.

In yet another exemplary embodiment, the lens assembly further includes a stop disposed between the second lens group and the third lens group and the second lens group can move along the optical axis for focusing.

In another exemplary embodiment, the lens assembly satisfies at least one of the following conditions: −0.76<fG2/f<−0.6; 0.8<fG3/f<1.8; 3.6<β2<6; 1.6<fG3/fG1<2.2; 0.75<TTL/fG3<1.05; 4.5<TTL/BFL<8; 0.7<f/TTL<0.9; 3.6<f/BFL<5.5; 0.4<T11ST/TSTIMA<0.7; 0.53<fG1/f<0.82; wherein f is an effective focal length of the lens assembly, fG1 is an effective focal length of the first lens group, fG2 is an effective focal length of the second lens group, fG3 is an effective focal length of the third lens group, TTL is an interval from an object side surface of a lens closest to the object side to an image plane along the optical axis, BFL is an interval from an image side surface of a lens closest to the image side to the image plane along the optical axis, T11ST is an interval from the object side surface of the lens closest to the object side to a stop along the optical axis, TSTIMA is an interval from the stop to the image plane along the optical axis, and β2 is a lateral magnification of the second lens group when an object is located at infinity.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens assembly in accordance with a fifth embodiment of the invention;

FIG. 2 depicts a field curvature diagram of the lens assembly in accordance with the fifth embodiment of the invention;

FIG. 3 depicts a distortion diagram of the lens assembly in accordance with the fifth embodiment of the invention;

FIG. 4 depicts a modulation transfer function diagram of the lens assembly in accordance with the fifth embodiment of the invention;

FIG. 5 depicts a Y field modulation transfer function diagram of the lens assembly in accordance with the fifth embodiment of the invention;

FIG. 6 depicts a through focus modulation transfer function diagram of the lens assembly in accordance with the fifth embodiment of the invention;

FIG. 7 is a lens layout and optical path diagram of a lens assembly in accordance with a sixth embodiment of the invention;

FIG. 8 depicts a field curvature diagram of the lens assembly in accordance with the sixth embodiment of the invention;

FIG. 9 depicts a distortion diagram of the lens assembly in accordance with the sixth embodiment of the invention;

FIG. 10 depicts a modulation transfer function diagram of the lens assembly in accordance with the sixth embodiment of the invention;

FIG. 11 depicts a Y field modulation transfer function diagram of the lens assembly in accordance with the sixth embodiment of the invention; and

FIG. 12 depicts a through focus modulation transfer function diagram of the lens assembly in accordance with the sixth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens group, a second lens group, and a third lens group. The lens groups of the lens assembly that are with refractive power are three in number. The first lens group is with positive refractive power. The second lens group is with negative refractive power. The third lens group is with positive refractive power. The first lens group, the second lens group, and the third lens group are arranged in order from an object side to an image side along an optical axis.

According to the foregoing, a lens assembly in accordance with a first embodiment of the invention, wherein the first lens group includes a lens, the lens is with positive refractive power, and the lens is a biconvex lens, a plano-convex lens, or a meniscus lens; the second lens group includes two lenses, the two lenses is with positive or negative refractive power but not all positive refractive power, and the two lenses are biconvex lenses, biconcave lenses, plano-convex lenses, plano-concave lenses, or meniscus lenses but not all biconvex lenses or plano-convex lenses; the third lens group includes a 3-1 lens, a 3-2 lens, a 3-3 lens, and a 3-4 lens, wherein the 3-1 lens is a biconvex lens with positive refractive power and closest to the object side in the third lens group, the 3-2 lens, the 3-3 lens, and the 3-4 lens are with positive or negative refractive power, the 3-2 lens and the 3-4 lens are biconvex lenses, biconcave lenses, plano-convex lenses, plano-concave lenses, or meniscus lenses, and the 3-3 lens includes a concave surface facing the image side and a convex surface, a plane surface, or a concave surface facing the object side; the two lenses closest to the image side are meniscus lenses among the second lens group and/or the third lens group; and the above design helps reducing field curvature. In operation, the light from the object side is imaged on an image plane. The first embodiment of the present invention can achieve basic operation through the above design.

According to the foregoing, a lens assembly in accordance with a second embodiment of the invention, wherein the first lens group includes a lens, the lens is with positive refractive power, and the lens is a biconvex lens, a plano-convex lens, or a meniscus lens; the second lens group includes two lenses, the two lenses are with positive or negative refractive power but not all positive refractive power, and the two lenses are biconvex lenses, biconcave lenses, plano-convex lenses, plano-concave lenses, or meniscus lenses but not all biconvex lenses or plano-convex lenses; the third lens group includes two lenses, the two lenses are with positive or negative refractive power but not all negative refractive power, and the two lenses are biconvex lenses, biconcave lenses, plano-convex lenses, plano-concave lenses, or meniscus lenses but not all biconcave lenses or plano-concave lenses; the lens closest to the object side is a biconvex lens with positive refractive power in the third lens group; and the adjacent lenses are with opposite refractive power in the second lens group and/or the third lens group, that is, the refractive powers of the lenses in the second lens group are positive, negative, or the refractive powers of the lenses in the third lens group are positive, negative, or the refractive powers of the lenses in the second lens group and the third lens group are negative, positive, negative, positive or positive, negative, positive, negative in order from the object side to the image side. In operation, the light from the object side is imaged on an image plane. The second embodiment of the present invention can achieve basic operation through the above design.

According to the foregoing, a lens assembly in accordance with a third embodiment of the invention, wherein the first lens group includes a 1-1 lens, a 1-2 lens, and a 1-3 lens; the 1-1 lens, the 1-2 lens, and the 1-3 lens are meniscus lenses having the same surface shapes facing the object side, the refractive powers are positive or negative, the 1-2 lens and the 1-3 lens are with the same refractive power, and the 1-1 lens and the 1-2 lens are with opposite refractive power; the second lens group includes a 2-1 lens, a 2-2 lens, and a 2-3 lens, all of which are arranged in order from the object side to the image side along the optical axis, one of the 2-1 lens, 2-2 lens, and 2-3 lens is a biconcave lens and the other two lenses are meniscus lenses, the two meniscus lenses have the same surface shapes facing the object side and have positive or negative refractive powers, the 2-1 lens and the 2-3 lens are with the same refractive power, and the 2-1 lens and the 2-2 lens are with opposite refractive power; the third lens group includes a 3-1 lens, a 3-2 lens, a 3-3 lens, and a 3-4 lens, all of which are arranged in order from the object side to the image side along the optical axis, the 3-1 lens is a biconvex lens with positive refractive power, the 3-2 lens, the 3-3 lens, and the 3-4 lens are meniscus lenses with positive or negative refractive power, the 3-2 lens and the 3-4 lens are with the same refractive power, the 3-2 lens and the 3-3 lens are with opposite refractive power; the second lens group and the third lens group have a total of five meniscus lenses; and the 1-1 lens, the 1-2 lens, and the 1-3 lens have the same surface shapes facing the image side or the 2-1 lens, the 2-2 lens, and the 2-3 lens have the same surface shapes facing the image side. In operation, the light from the object side is imaged on an image plane. The third embodiment of the present invention can achieve basic operation through the above design.

According to the foregoing, a lens assembly in accordance with a fourth embodiment of the invention, wherein the 1-1 lens is a meniscus lens with negative refractive power and includes a convex surface facing the object side and a concave surface facing the image side; the 1-2 lens is a meniscus lens with positive refractive power and includes a convex surface facing the object side and a concave surface facing the image side; the 1-3 lens is a meniscus lens with positive refractive power and includes a convex surface facing the object side and a concave surface facing the image side; the 2-1 lens is a biconcave lens with negative refractive power and includes a concave surface facing the object side and another concave surface facing the image side; the 2-2 lens is a meniscus lens with positive refractive power and includes a convex surface facing the object side and a concave surface facing the image side; the 2-3 lens is a meniscus lens with negative refractive power and includes a convex surface facing the object side and a concave surface facing the image side; the 3-1 lens is a biconvex lens with positive refractive power and includes a convex surface facing the object side and another convex surface facing the image side; the 3-2 lens is a meniscus lens with negative refractive power and includes a convex surface facing the object side and a concave surface facing the image side; the 3-3 lens is a meniscus lens with positive refractive power and includes a convex surface facing the object side and a concave surface facing the image side; and the 3-4 lens is a meniscus lens with negative refractive power and includes a concave surface facing the object side and a convex surface facing the image side. In operation, the light from the object side is imaged on an image plane. The fourth embodiment of the present invention can achieve basic operation through the above design.

In addition, the lens assemblies of the above embodiments can effectively reduce chromatic aberration and improve resolution by further satisfying condition: 85<VdG1P<90, wherein VdG1P is an average Abbe number of the lenses with the positive refractive power in the first lens group. Satisfying the condition: 85<VdG1P<90, the basic operation can be achieved. In another embodiment, the lens assemblies of the above embodiments can effectively improve resolution by further satisfying condition: −0.76<fG2/f<−0.6, wherein fG2 is an effective focal length of the second lens group and f is an effective focal length of the lens assembly. Satisfying the condition: −0.76<fG2/f<−0.6, the basic operation can be achieved. In yet another embodiment, the lens assemblies of the above embodiments can effectively reduce sensitivity by further satisfying condition: 0.8<fG3/f<1.8, wherein fG3 is an effective focal length of the third lens group and f is an effective focal length of the lens assembly. Satisfying the condition: 0.8<fG3/f<1.8, the basic operation can be achieved. In another embodiment, the lens assemblies of the above embodiments can effectively improve focusing ability by further satisfying condition: 1.6<fG3/fG1<2.2, wherein fG3 is an effective focal length of the third lens group and fG1 is an effective focal length of the first lens group. Satisfying the condition: 1.6<fG3/fG1<2.2, the basic operation can be achieved. In yet another embodiment, the lens assemblies of the above embodiments can effectively decrease total lens length by further satisfying condition: 0.75<TTL/fG3<1.05, wherein fG3 is an effective focal length of the third lens group and TTL is an interval from an object side surface of the lens closest to the object side to an image plane along an optical axis. Satisfying the condition: 0.75<TTL/fG3<1.05, the basic operation can be achieved. In another embodiment, the lens assemblies of the above embodiments can effectively increase the back focal length and improve the production yield of the lens assembly by further satisfying condition: 4.5<TTL/BFL<8, wherein TTL is an interval from an object side surface of the lens closest to the object side to an image plane along an optical axis and BFL is an interval from an image side surface of the lens closest to the image side to the image plane along an optical axis. Satisfying the condition: 4.5<TTL/BFL<8, the basic operation can be achieved. In yet another embodiment, the lens assemblies of the above embodiments can effectively decrease total lens length by further satisfying condition: 0.7<f/TTL<0.9, wherein TTL is an interval from an object side surface of the lens closest to the object side to an image plane along an optical axis and f is an effective focal length of the lens assembly. Satisfying the condition: 0.7<f/TTL<0.9, the basic operation can be achieved. In another embodiment, the lens assemblies of the above embodiments can effectively increase the back focal length and improve the production yield of the lens assembly by further satisfying condition: 3.6<f/BFL<5.5, wherein BFL is an interval from an image side surface of the lens closest to the image side to an image plane along an optical axis and f is an effective focal length of the lens assembly. Satisfying the condition: 3.6<f/BFL<5.5, the basic operation can be achieved. In yet another embodiment, the lens assemblies of the above embodiments can effectively improve the production yield of the lens assembly by further satisfying condition: 0.4<T11ST/TSTIMA<0.7, wherein T11ST is an interval from an object side surface of the lens closest to the object side to a stop along an optical axis and TSTIMA is an interval from the stop to an image plane along the optical axis. Satisfying the condition: 0.4<T11ST/TSTIMA<0.7, the basic operation can be achieved. In another embodiment, the lens assemblies of the above embodiments can effectively increase resolution by further satisfying condition: 0.53<fG1/f<0.82, wherein fG1 is an effective focal length of the first lens group and f is an effective focal length of the lens assembly. Satisfying the condition: 0.53<fG1/f<0.82, the basic operation can be achieved.

Referring to Table 1, Table 2, Table 4, and Table 5, wherein Table 1 and Table 4 show optical specification in accordance with a fifth and sixth embodiments of the invention, respectively, and Table 2 and Table 5 show aspheric coefficients of each aspheric lens in Table 1 and Table 4, respectively.

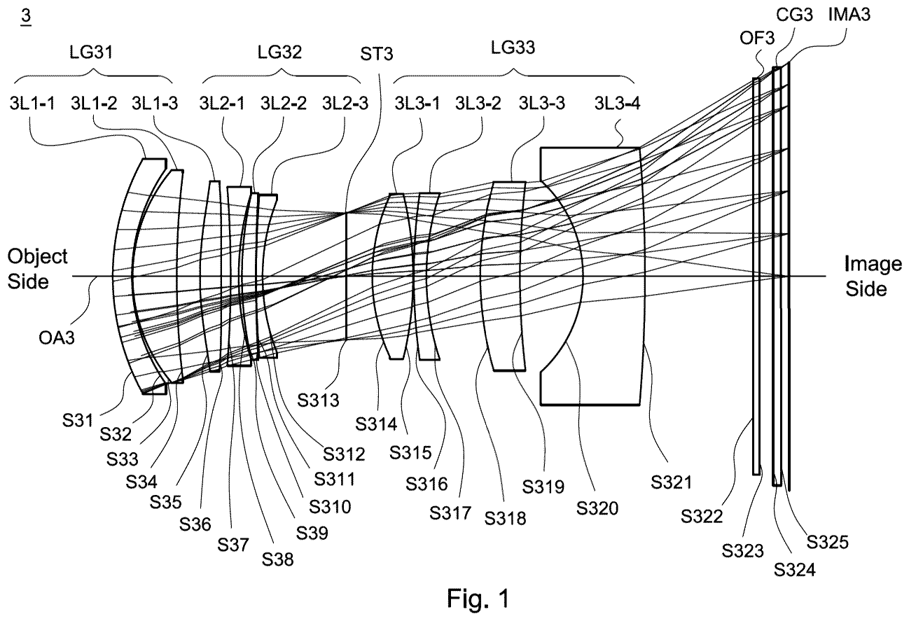

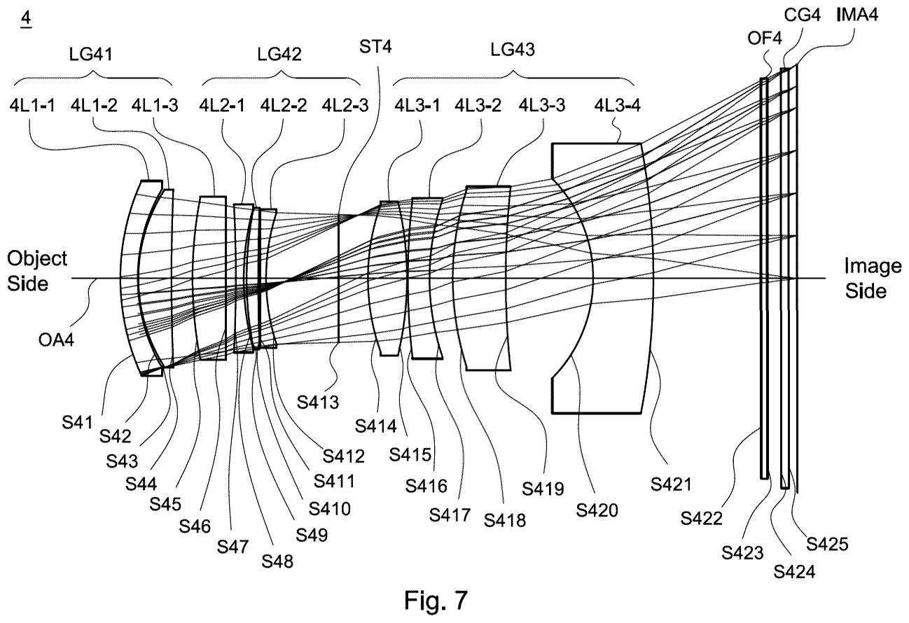

FIGS. 1 and 7 are lens layout and optical path diagrams of the lens assemblies in accordance with the fifth and sixth embodiments of the invention, respectively.

The 1-1 lenses 3L1-1, 4L1-1 are meniscus lenses with negative refractive power, wherein the object side surfaces S31, S41 are convex surfaces, the image side surfaces S32, S42 are concave surfaces, and both of the object side surfaces S31, S41 and image side surfaces S32, S42 are spherical surfaces.

The 1-2 lenses 3L1-2, 4L1-2 are meniscus lenses with positive refractive power, wherein the object side surfaces S33, S43 are convex surfaces, the image side surfaces S34, S44 are concave surfaces, and both of the object side surfaces S33, S43 and image side surfaces S34, S44 are spherical surfaces.

The 1-3 lenses 3L1-3, 4L1-3 are meniscus lenses with positive refractive power, wherein the object side surfaces S35, S45 are convex surfaces, the image side surfaces S36, S46 are concave surfaces, and both of the object side surfaces S35, S45 and image side surfaces S36, S46 are aspheric surfaces.

The 2-1 lenses 3L2-1, 4L2-1 are biconcave lenses with negative refractive power, wherein the object side surfaces S37, S47 are concave surfaces, the image side surfaces S38, S48 are concave surfaces, and both of the object side surfaces S37, S47 and image side surfaces S38, S48 are spherical surfaces.

The 2-2 lenses 3L2-2, 4L2-2 are meniscus lenses with positive refractive power, wherein the object side surfaces S39, S49 are convex surfaces, the image side surfaces S310, S410 are concave surfaces, and both of the object side surfaces S39, S49 and image side surfaces S310, S410 are spherical surfaces.

The 2-3 lenses 3L2-3, 4L2-3 are meniscus lenses with negative refractive power, wherein the object side surfaces S311, S411 are convex surfaces, the image side surfaces S312, S412 are concave surfaces, and both of the object side surfaces S311, S411 and image side surfaces S312, S412 are spherical surfaces.

The 3-1 lenses 3L3-1, 4L3-1 are biconvex lenses with positive refractive power, wherein the object side surfaces S314, S414 are convex surfaces, the image side surfaces S315, S415 are convex surfaces, and both of the object side surfaces S314, S414 and image side surfaces S315, S415 are spherical surfaces.

The 3-2 lenses 3L3-2, 4L3-2 are meniscus lenses with negative refractive power, wherein the object side surfaces S316, S416 are convex surfaces, the image side surfaces S317, S417 are concave surfaces, and both of the object side surfaces S316, S416 and image side surfaces S317, S417 are spherical surfaces.

The 3-3 lenses 3L3-3, 4L3-3 are meniscus lenses with positive refractive power, wherein the object side surfaces S318, S418 are convex surfaces, the image side surfaces S319, S419 are concave surfaces, and both of the object side surfaces S318, S418 and image side surfaces S319, S419 are spherical surfaces.

The 3-4 lenses 3L3-4, 4L3-4 are meniscus lenses with negative refractive power, wherein the object side surfaces S320, S420 are concave surfaces, the image side surfaces S321, S421 are convex surfaces, and both of the object side surfaces S320, S420 and image side surfaces S321, S421 are spherical surfaces.

In addition, the lens assemblies 3 and 4 can optimize the performance by satisfying at least one of the following conditions (1)-(11). The optimized performance is described in the foregoing and is not described here again.

$$85 < VdG 1 P < 90 ; \qquad ( 1 )$$

$$- 0.76 < fG 2 / f < - 0.6 ; \qquad ( 2 )$$

$$0.8 < fG 3 / f < 1.8 ; \qquad ( 3 )$$

$$3.6 < β2 < 6 ; \qquad ( 4 )$$

$$1.6 < fG 3 / fG 1 < 2.2 ; \qquad ( 5 )$$

$$0.75 < TTL / fG 3 < 1.05 ; \qquad ( 6 )$$

$$4.5 < TTL / BFL < 8 ; \qquad ( 7 )$$

$$0.7 < f / TTL < 0.9 ; \qquad ( 8 )$$

$$3.6 < f / BFL < 5.5 ; \qquad ( 9 )$$

$$0.4 < T 11 ST / TSTIMA < 0.7 ; \qquad ( 10 )$$

$$0.53 < fG 1 / f < 0.82 ; \qquad ( 11 )$$

wherein: VdG1P is an average Abbe number of the lenses with positive refractive power of the first lens groups LG31, LG41 for the fifth to sixth embodiments; f is an effective focal length of the lens assemblies 3, 4 for the fifth to sixth embodiments; fG1 is an effective focal length of the first lens groups LG31, LG41 for the fifth to sixth embodiments; fG2 is an effective focal length of the second lens groups LG32, LG42 for the fifth to sixth embodiments; fG3 is an effective focal length of the third lens groups LG33, LG43 for the fifth to sixth embodiments; TTL is an interval from the object side surfaces S31, S41 of the lenses 3L1-1, 4L1-1 closest to the object side to the image planes IMA3, IMA4 along the optical axes OA3, OA4 for the fifth to sixth embodiments; BFL is an interval from the image side surfaces S321, S421 of the lenses 3L3-4, 4L3-4 closest to the image side to the image planes IMA3, IMA4 along the optical axes OA3, OA4 for the fifth to sixth embodiments; T11ST is an interval from the object side surfaces S31, S41 of the lenses 3L1-1, 4L1-1 closest to the object side to the stops ST3, ST4 along the optical axes OA3, OA4 for the fifth to sixth embodiments; TSTIMA is an interval from the stops ST3, ST4 to the image planes IMA3, IMA4 along the optical axes OA3, OA4 for the fifth to sixth embodiments; and B2 is a lateral magnification of the second lens groups LG32, LG42 when the object is located at infinity for the fifth to sixth embodiments. With the lens assemblies 3, 4 satisfying at least one of the above conditions (1)-(11), the total lens length can be effectively decreased, the resolution can be effectively increased, and the aberration can be effectively corrected.

A detailed description of a lens assembly in accordance with a fifth embodiment of the invention is as follows. Referring to FIG. 1, the lens assembly 3 includes a first lens group LG31, a second lens group LG32, a stop ST3, a third lens group LG33, an optical filter OF3, and a cover glass CG3, all of which are arranged in order from an object side to an image side along an optical axis OA3. The first lens group LG31 is with positive refractive power and includes a 1-1 lens 3L1-1, a 1-2 lens 3L1-2, and a 1-3 lens 3L1-3, all of which are arranged in order from the object side to the image side along the optical axis. The second lens group LG32 is with negative refractive power and includes a 2-1 lens 3L2-1, a 2-2 lens 3L2-2, and a 2-3 lens 3L2-3, all of which are arranged in order from the object side to the image side along the optical axis. The third lens group LG33 is with positive refractive power and includes a 3-1 lens 3L3-1, a 3-2 lens 3L3-2, a 3-3 lens 3L3-3, and a 3-4 lens 3L3-4, all of which are arranged in order from the object side to the image side along the optical axis. In operation, the light from the object side is imaged on an image plane IMA3.

According to the foregoing, wherein: both of the object side surface S322 and image side surface S323 of the optical filter OF3 are plane surfaces; both of the object side surface S324 and image side surface S325 of the cover glass CG3 are plane surfaces; and with the above design of the lenses, stop ST3, and at least one of the conditions (1)-(11) satisfied, the lens assembly 3 can have an effective decreased total lens length, an effective increased resolution, and an effective corrected aberration.

TABLE 1
Effective Focal Length = 74.964235 mm F-number = 3.47
Total Lens Length = 85.014 mm Field of View = 39.550 degrees

| | | | | | Effective | |
|---|---|---|---|---|---|---|
| | Radius of | Thick- | | | Focal | |
| Surface | Curvature | ness | | | Length | |
| Number | (mm) | (mm) | Nd | Vd | (mm) | Remark |
| S31 | 32.2030 | 2.386 | 1.80518 | 25.45626 | −149.4105 | 3L1-1 |
| S32 | 24.5633 | 0.050 | | | | |
| S33 | 21.3568 | 5.585 | 1.43700 | 95.10039 | 58.9535 | 3L1-2 |
| S34 | 114.9486 | 2.908 | | | | |
| S35 | 43.1959 | 2.671 | 1.49731 | 82.50640 | 89.5660 | 3L1-3 |
| S36 | 1398.2408 | 1.212 | | | | |
| S37 | −146.4860 | 0.977 | 1.49967 | 62.07198 | −58.8513 | 3L2-1 |
| S38 | 36.8738 | 0.411 | | | | |
| S39 | 48.1285 | 1.740 | 1.84666 | 23.78450 | 75.7036 | 3L2-2 |
| S310 | 189.9991 | 0.060 | | | | |
| S311 | 138.3497 | 0.786 | 1.51742 | 52.14925 | −66.0458 | 3L2-3 |
| S312 | 27.3512 | 10.525 | | | | |
| S313 | ∞ | 3.294 | | | | ST3 |
| S314 | 25.5902 | 5.108 | 1.43780 | 94.52339 | 38.3218 | 3L3-1 |
| S315 | −45.7556 | 0.099 | | | | |
| S316 | 78.0926 | 1.586 | 1.84666 | 23.78450 | −75.9512 | 3L3-2 |
| S317 | 34.9373 | 6.829 | | | | |
| S318 | 44.5134 | 4.918 | 1.75520 | 27.53005 | 102.2840 | 3L3-3 |
| S319 | 100.0557 | 7.792 | | | | |
| S320 | −17.2989 | 7.930 | 1.43780 | 94.52339 | −43.6594 | 3L3-4 |
| S321 | −207.5835 | 13.597 | | | | |
| S322 | ∞ | 0.800 | 1.51680 | 64.16734 | | OF3 |
| S323 | ∞ | 1.700 | | | | |
| S324 | ∞ | 1.000 | 1.51680 | 64.16734 | | CG3 |
| S325 | ∞ | 1.050 | | | | |

The aspheric surface sag z of each aspheric lens in table 1 can be calculated by the following formula:

$$z = {ch}^{2} / \{ 1 + {[ 1 - ( k + 1 ) {c}^{2} {h}^{2} ]}^{1 / 2} \} + {Ah}^{4} + {Bh}^{6} + {Ch}^{8} + {Dh}^{10} + {Eh}^{12} + {Fh}^{14}$$

where c is curvature, h is the vertical distance from the lens surface to the optical axis, k is conic constant and A, B, C, D, E, and F are aspheric coefficients.

In the fifth embodiment, the conic constant k and the aspheric coefficients A, B, C, D, E, F of each aspheric lens are shown in Table 2.

TABLE 2

| Surface | | A | B | | |
|---|---|---|---|---|---|
| Number | k | E | F | C | D |
| S35 | 0.0000E+00 | 0.0000E+00 | −1.7632E−05 | −2.5021E−08 | 1.5312E−10 |
| | | −2.8163E−12 | 1.0576E−14 | | |
| S36 | 0.0000E+00 | 0.0000E+00 | −1.3612E−05 | 2.3143E−08 | −1.5177E−10 |
| | | −9.7455E−13 | 6.9710E−15 | | |

Table 3 shows the parameters and condition values for conditions (1)-(11) in accordance with the fifth embodiment of the invention. It can be seen from Table 3 that the lens assembly 3 of the fifth embodiment satisfies the conditions (1)-(11).

TABLE 3

| fG1 | 51.174964 | mm | fG2 | −52.515951 | mm | fG3 | 104.648400 mm |
|---|---|---|---|---|---|---|---|
| VdG1P | 88.80 | | BFL | 18.147 | mm | β2 | 4.314 |
| T11ST | 29.311 | mm | TSTIMA | 55.703 | mm | | |

| | | | | | |
|---|---|---|---|---|---|
| fG2/f | −0.701 | fG3/f | 1.396 | fG1/f | 0.683 |
| fG3/fG1 | 2.045 | TTL/fG3 | 0.812 | TTL/BFL | 4.685 |
| f/TTL | 0.882 | f/BFL | 4.131 | T11ST/TSTIMA | 0.526 |

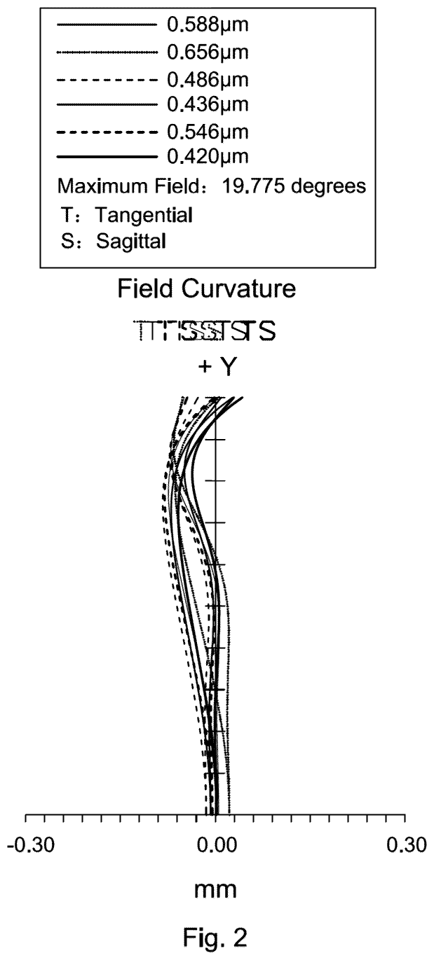

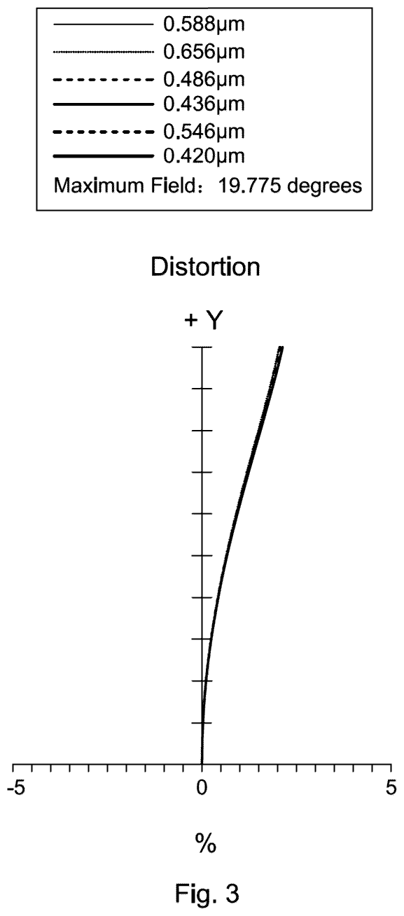

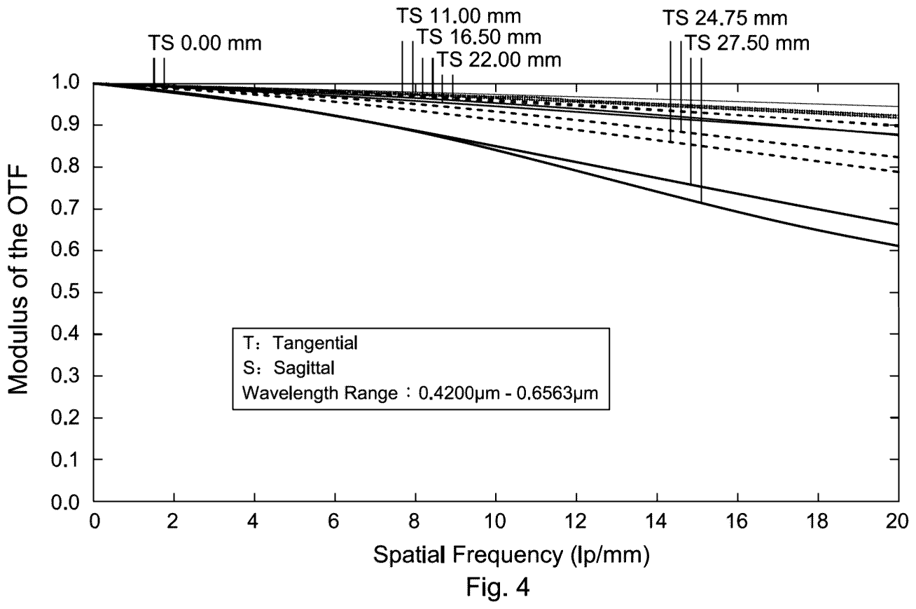

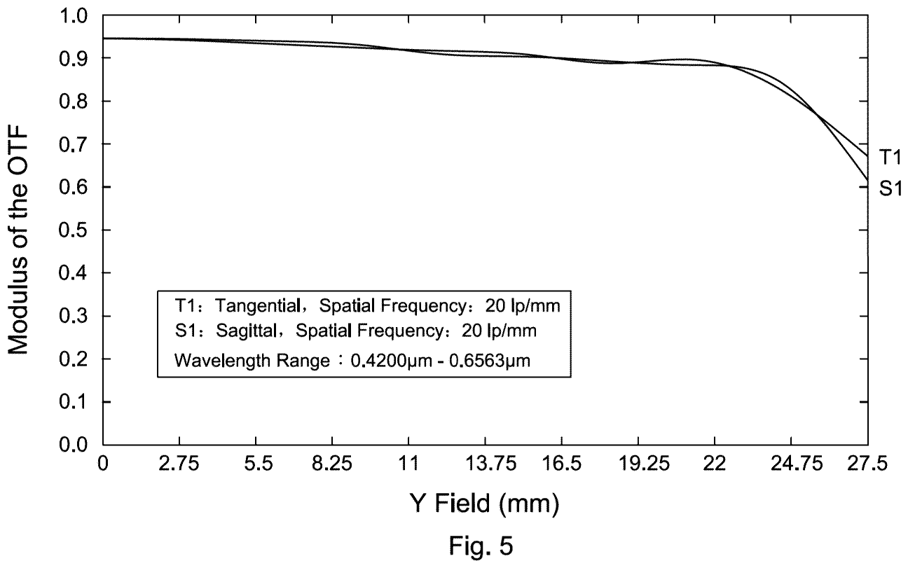

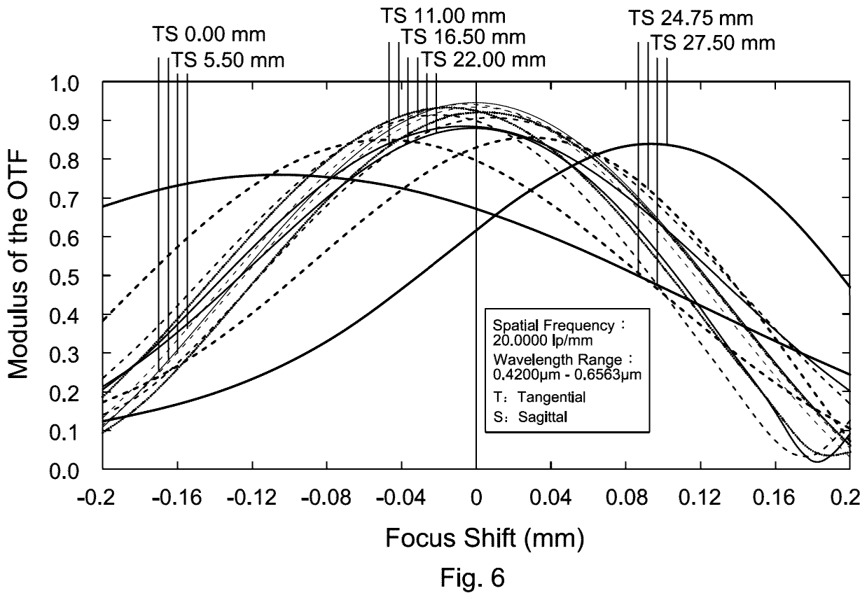

In addition, the lens assembly 3 of the fifth embodiment can meet the requirements of optical performance as seen in FIGS. 2-6. It can be seen from FIG. 2 that the field curvature of tangential direction and sagittal direction in the lens assembly 3 of the fifth embodiment ranges from −0.09 mm to 0.06 mm. It can be seen from FIG. 3 that the distortion in the lens assembly 3 of the fifth embodiment ranges from 0% to 2.5%. It can be seen from FIG. 4 that the modulation transfer function of tangential direction and sagittal direction in the lens assembly 3 of the fifth embodiment ranges from 0.62 to 1.0. It can be seen from FIG. 5 that the Y field modulation transfer function of tangential direction and sagittal direction in the lens assembly 3 of the fifth embodiment ranges from 0.62 to 0.95. It can be seen from FIG. 6 that the through focus modulation transfer function of tangential direction and sagittal direction in the lens assembly 3 of the fifth embodiment ranges from 0.02 to 0.95 as focus shift ranges from −0.2 mm to 0.2 mm. It is obvious that the field curvature and the distortion of the lens assembly 3 of the fifth embodiment can be corrected effectively, and the resolution and the depth of focus of the lens assembly 3 of the fifth embodiment can meet the requirement. Therefore, the lens assembly 3 of the fifth embodiment is capable of good optical performance.

A detailed description of a lens assembly in accordance with a sixth embodiment of the invention is as follows. Referring to FIG. 7, the lens assembly 4 includes a first lens group LG41, a second lens group LG42, a stop ST4, a third lens group LG43, an optical filter OF4, and a cover glass CG4, all of which are arranged in order from an object side to an image side along an optical axis OA4. The first lens group LG41 is with positive refractive power and includes a 1-1 lens 4L1-1, a 1-2 lens 4L1-2, and a 1-3 lens 4L1-3, all of which are arranged in order from the object side to the image side along the optical axis. The second lens group LG42 is with negative refractive power and includes a 2-1 lens 4L2-1, a 2-2 lens 4L2-2, and a 2-3 lens 4L2-3, all of which are arranged in order from the object side to the image side along the optical axis. The third lens group LG43 is with positive refractive power and includes a 3-1 lens 4L3-1, a 3-2 lens 4L3-2, a 3-3 lens 4L3-3, and a 3-4 lens 4L3-4, all of which are arranged in order from the object side to the image side along the optical axis. In operation, the light from the object side is imaged on an image plane IMA4.

According to the foregoing, wherein: both of the object side surface S422 and image side surface S423 of the optical filter OF4 are plane surfaces; both of the object side surface S424 and image side surface S425 of the cover glass CG4 are plane surfaces; and with the above design of the lenses, stop ST4, and at least one of the conditions (1)-(11) satisfied, the lens assembly 4 can have an effective decreased total lens length, an effective increased resolution, and an effective corrected aberration.

TABLE 4
Effective Focal Length = 74.925316 mm F-number = 3.46
Total Lens Length = 85.026 mm Field of View = 39.546 degrees

| | | | | | Effective | |
|---|---|---|---|---|---|---|
| | Radius of | Thick- | | | Focal | |
| Surface | Curvature | ness | | | Length | |
| Number | (mm) | (mm) | Nd | Vd | (mm) | Remark |
| S41 | 30.7851 | 2.229 | 1.80518 | 25.45626 | −141.2634 | 4L1-1 |
| S42 | 23.4453 | 0.050 | | | | |
| S43 | 21.4945 | 4.128 | 1.43700 | 95.10039 | 52.9392 | 4L1-2 |
| S44 | 285.5135 | 2.592 | | | | |
| S45 | 44.9463 | 4.251 | 1.49646 | 82.50640 | 102.2313 | 4L1-3 |
| S46 | 380.4718 | 1.247 | | | | |
| S47 | −185.9621 | 0.980 | 1.49967 | 62.07198 | −58.0686 | 4L2-1 |
| S48 | 34.4396 | 0.380 | | | | |
| S49 | 47.8413 | 1.455 | 1.84666 | 23.78450 | 69.6722 | 4L2-2 |
| S410 | 249.6310 | 0.202 | | | | |
| S411 | 4448.0471 | 0.779 | 1.51742 | 52.14925 | −54.7763 | 4L2-3 |
| S412 | 28.1612 | 9.101 | | | | |
| S413 | ∞ | 3.700 | | | | ST4 |
| S414 | 29.0955 | 4.904 | 1.43780 | 94.52339 | 40.4051 | 4L3-1 |
| S415 | −42.8073 | 0.081 | | | | |
| S416 | 87.2279 | 2.763 | 1.84666 | 23.78450 | −63.0256 | 4L3-2 |
| S417 | 32.6270 | 2.945 | | | | |
| S418 | 38.4730 | 6.627 | 1.75520 | 27.53005 | 74.3836 | 4L3-3 |
| S419 | 113.0430 | 10.993 | | | | |
| S420 | −18.4877 | 7.518 | 1.48749 | 70.44049 | −48.2651 | 4L3-4 |
| S421 | −97.7898 | 13.551 | | | | |
| S422 | ∞ | 0.800 | 1.51680 | 64.16734 | | OF4 |
| S423 | ∞ | 1.700 | | | | |
| S424 | ∞ | 1.000 | 1.51680 | 64.16734 | | CG4 |
| S425 | ∞ | 1.050 | | | | |

The definition of aspheric surface sag z of each aspheric lens in Table 4 is the same as that of in Table 1, and is not described here again.

In the sixth embodiment, the conic constant k and the aspheric coefficients A, B, C, D, E, F of each aspheric lens are shown in Table 5.

TABLE 5

| Surface | | A | B | | |
|---|---|---|---|---|---|
| Number | k | E | F | C | D |
| S45 | 0.0000E+00 | 0.0000E+00 | −1.2841E−05 | −2.8873E−08 | 7.9104E−12 |
| | | −2.3046E−13 | 1.0861E−15 | | |
| S46 | 0.0000E+00 | 0.0000E+00 | −1.0043E−05 | −2.6174E−08 | 2.1366E−10 |
| | | −1.5871E−12 | 5.2759E−15 | | |

Table 6 shows the parameters and condition values for conditions (1)-(11) in accordance with the sixth embodiment of the invention. It can be seen from Table 6 that the lens assembly 4 of the sixth embodiment satisfies the conditions (1)-(11).

TABLE 6

| fG1 | 49.876830 | mm | fG2 | −47.102467 | mm | fG3 | 87.654451 mm |
|---|---|---|---|---|---|---|---|
| VdG1P | 88.80 | | BFL | 18.101 | mm | β2 | 5.631 |
| T11ST | 27.394 | mm | TSTIMA | 57.632 | mm | | |

| | | | | | |
|---|---|---|---|---|---|
| fG2/f | −0.629 | fG3/f | 1.17 | fG1/f | 0.666 |
| fG3/fG1 | 1.757 | TTL/fG3 | 0.970 | TTL/BFL | 4.697 |
| f/TTL | 0.881 | f/BFL | 4.139 | T11ST/TSTIMA | 0.475 |

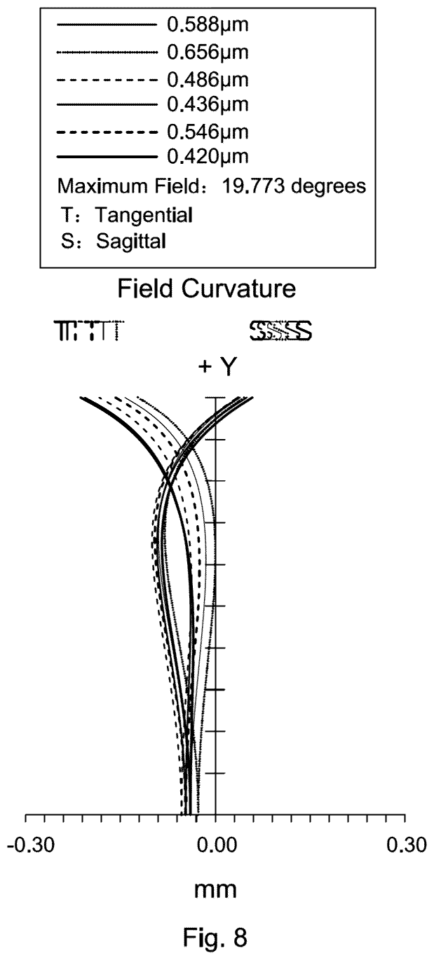

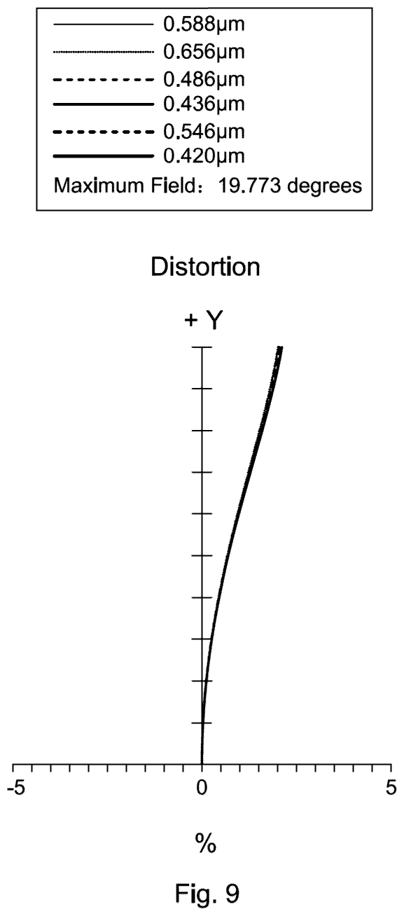

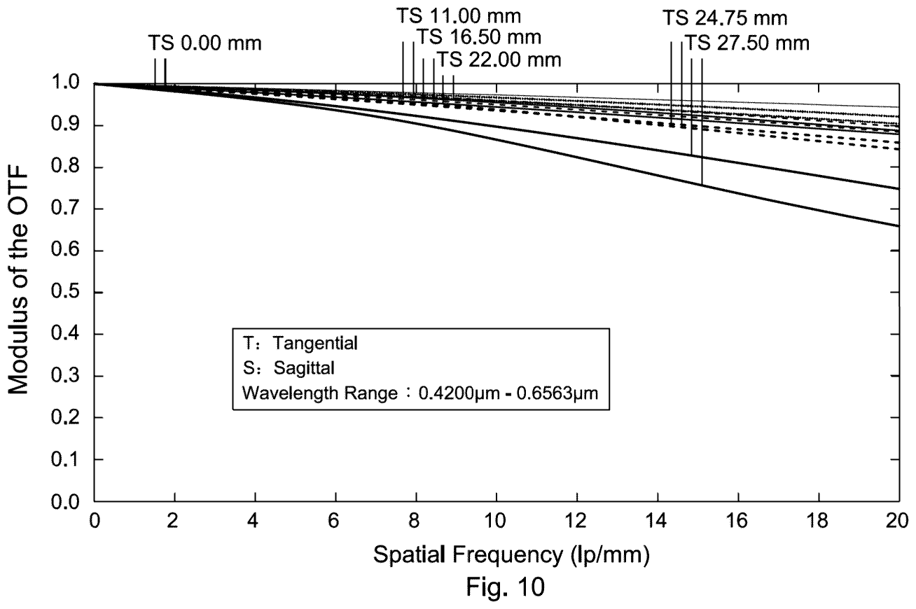

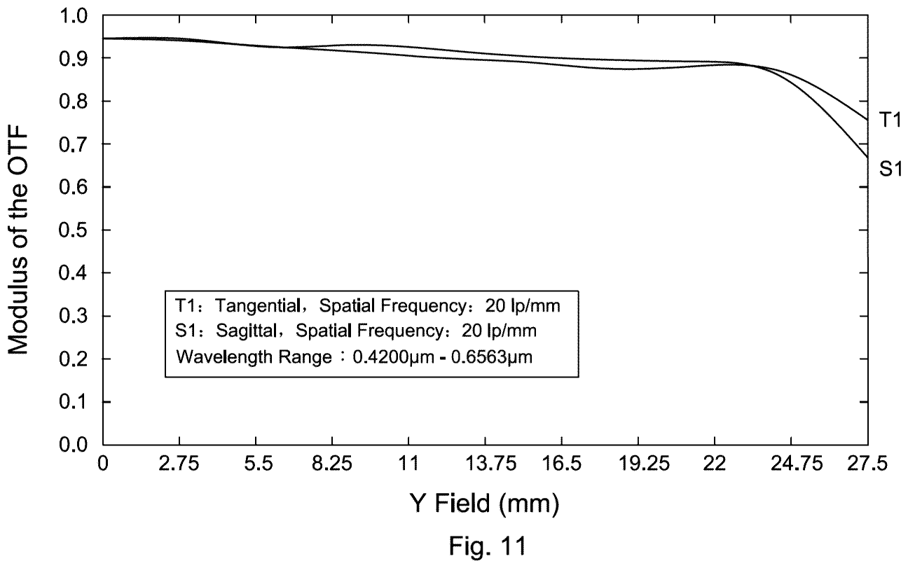

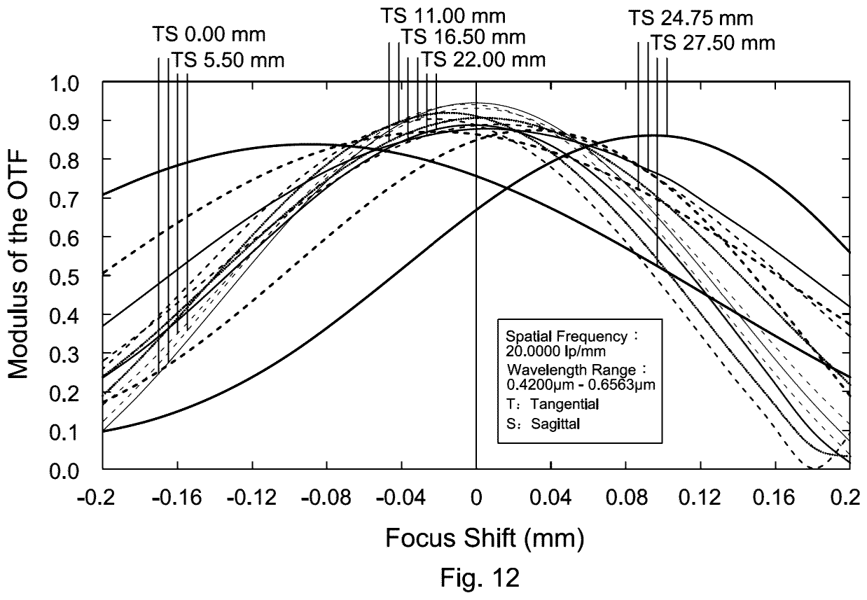

In addition, the lens assembly 4 of the sixth embodiment can meet the requirements of optical performance as seen in FIGS. 8-12. It can be seen from FIG. 8 that the field curvature of tangential direction and sagittal direction in the lens assembly 4 of the sixth embodiment ranges from −0.21 mm to 0.06 mm. It can be seen from FIG. 9 that the distortion in the lens assembly 4 of the sixth embodiment ranges from 0% to 2.5%. It can be seen from FIG. 10 that the modulation transfer function of tangential direction and sagittal direction in the lens assembly 4 of the sixth embodiment ranges from 0.66 to 1.0. It can be seen from FIG. 11 that the Y field modulation transfer function of tangential direction and sagittal direction in the lens assembly 4 of the sixth embodiment ranges from 0.67 to 0.95. It can be seen from FIG. 12 that the through focus modulation transfer function of tangential direction and sagittal direction in the lens assembly 4 of the sixth embodiment ranges from 0.00 to 0.95 as focus shift ranges from −0.2 mm to 0.2 mm. It is obvious that the field curvature and the distortion of the lens assembly 4 of the sixth embodiment can be corrected effectively, and the resolution and the depth of focus of the lens assembly 4 of the sixth embodiment can meet the requirement. Therefore, the lens assembly 4 of the sixth embodiment is capable of good optical performance.

In the above embodiments 1 to 6, the first lens group has positive refractive power and the 1-3 lens is an aspherical lens which can effectively improve resolution. In the above embodiments 1 to 6, the lenses in the first lens group and/or the second lens group are designed with concave surfaces facing the image side which can effectively decrease the total lens length. In any one of the above embodiments 1 to 6, in another embodiment, the second lens group is a focusing lens group that can move along the optical axis for focusing. This design cooperates the adjacent lenses with opposite refractive power in the second lens group and/or the third lens group, or the lens closest to the object side is with positive refractive power in the second lens group and the third lens group helping focus sensitivity matching movement range.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens group which is with positive refractive power;
a second lens group which is with negative refractive power and comprises at least two lenses; and
a third lens group which is with positive refractive power and comprises a 3-1 lens, a 3-2 lens, a 3-3 lens, and a 3-4 lens;
wherein the first lens group, the second lens group, and the third lens group are arranged in order from an object side to an image side along an optical axis;
wherein the lens groups of the lens assembly that are with refractive power are three in number;
wherein the 3-1 lens, the 3-2 lens, the 3-3 lens, and the 3-4 lens are arranged in order from the object side to the image side along the optical axis;
wherein the 3-1 lens is a biconvex lens with positive refractive power and comprises a convex surface facing the object side and another convex surface facing the image side;
wherein the 3-3 lens comprises a concave surface facing the image side;
wherein two lenses closest to the image side are meniscus lenses among the second lens group and the third lens group.

2. The lens assembly as claimed in claim 1, further comprising a stop disposed between the second lens group and the third lens group and the second lens group can move along the optical axis for focusing.

3. The lens assembly as claimed in claim 1, wherein the lens assembly satisfies at least one of following conditions:
$$- 0.76 < fG 2 / f < - 0.6 ;$$
$$0.8 < fG 3 / f < 1.8 ;$$
$$3.6 < β2 < 6 ;$$
$$1.6 < fG 3 / fG 1 < 2.2 ;$$
$$0.75 < TTL / fG 3 < 1.05 ;$$
$$4.5 < TTL / BFL < 8 ;$$
$$0.7 < f / TTL < 0.9 ;$$
$$3.6 < f / BFL < 5.5 ;$$
$$0.4 < T 11 ST / TSTIMA < 0.7 ;$$
$$0.53 < fG 1 / f < 0.82 ;$$
wherein f is an effective focal length of the lens assembly, fG1 is an effective focal length of the first lens group, fG2 is an effective focal length of the second lens group, fG3 is an effective focal length of the third lens group, TTL is an interval from an object side surface of a lens closest to the object side to an image plane along the optical axis, BFL is an interval from an image side surface of a lens closest to the image side to the image plane along the optical axis, T11ST is an interval from the object side surface of the lens closest to the object side to a stop along the optical axis, TSTIMA is an interval from the stop to the image plane along the optical axis, and β2 is a lateral magnification of the second lens group when an object is located at infinity.

4. The lens assembly as claimed in claim 1, wherein the refractive powers of adjacent lenses in the second lens group or the third lens group are opposite.

5. The lens assembly as claimed in claim 4, further comprising a stop disposed between the second lens group and the third lens group and the second lens group can move along the optical axis for focusing.

6. The lens assembly as claimed in claim 4, wherein the lens assembly satisfies at least one of following conditions:
$$- 0.76 < fG 2 / f < - 0.6 ;$$
$$0.8 < fG 3 / f < 1.8 ;$$
$$3.6 < β2 < 6 ;$$
$$1.6 < fG 3 / fG 1 < 2.2 ;$$
$$0.75 < TTL / fG 3 < 1.05 ;$$
$$4.5 < TTL / BFL < 8 ;$$
$$0.7 < f / TTL < 0.9 ;$$
$$3.6 < f / BFL < 5.5 ;$$
$$0.4 < T 11 ST / TSTIMA < 0.7 ;$$
$$0.53 < fG 1 / f < 0.82 ;$$
wherein f is an effective focal length of the lens assembly, fG1 is an effective focal length of the first lens group, fG2 is an effective focal length of the second lens group, fG3 is an effective focal length of the third lens group, TTL is an interval from an object side surface of a lens closest to the object side to an image plane along the optical axis, BFL is an interval from an image side surface of a lens closest to the image side to the image plane along the optical axis, T11ST is an interval from the object side surface of the lens closest to the object side to a stop along the optical axis, TSTIMA is an interval from the stop to the image plane along the optical axis, and β2 is a lateral magnification of the second lens group when an object is located at infinity.

7. A lens assembly comprising:
a first lens group which is with positive refractive power;
a second lens group which is with negative refractive power; and
a third lens group which is with positive refractive power;
wherein the first lens group, the second lens group, and the third lens group are arranged in order from an object side to an image side along an optical axis;
wherein the lens groups of the lens assembly that are with refractive power are three in number;
wherein a lens closest to the object side in the third lens group is a biconvex lens with positive refractive power and comprises a convex surface facing the object side and another convex surface facing the image side;
wherein two lenses closest to the image side in the second lens group are meniscus lenses;
wherein the third lens group comprises a plurality of lenses and adjacent lenses among the lenses have opposite refractive powers.

8. The lens assembly as claimed in claim 7, further comprising a stop disposed between the second lens group and the third lens group and the second lens group can move along the optical axis for focusing.

9. The lens assembly as claimed in claim 7, wherein the lens assembly satisfies at least one of following conditions:
$$- 0.76 < fG 2 / f < - 0.6 ;$$
$$0.8 < fG 3 / f < 1.8 ;$$
$$3.6 < β2 < 6 ;$$
$$1.6 < fG 3 / fG 1 < 2.2 ;$$
$$0.75 < TTL / fG 3 < 1.05 ;$$
$$4.5 < TTL / BFL < 8 ;$$
$$0.7 < f / TTL < 0.9 ;$$
$$3.6 < f / BFL < 5.5 ;$$
$$0.4 < T 11 ST / TSTIMA < 0.7 ;$$
$$0.53 < fG 1 / f < 0.82 ;$$
wherein f is an effective focal length of the lens assembly, fG1 is an effective focal length of the first lens group, fG2 is an effective focal length of the second lens group, fG3 is an effective focal length of the third lens group, TTL is an interval from an object side surface of a lens closest to the object side to an image plane along the optical axis, BFL is an interval from an image side surface of a lens closest to the image side to the image plane along the optical axis, T11ST is an interval from the object side surface of the lens closest to the object side to a stop along the optical axis, TSTIMA is an interval from the stop to the image plane along the optical axis, and β2 is a lateral magnification of the second lens group when an object is located at infinity.

10. The lens assembly as claimed in claim 7, wherein:
the third lens group comprises a 3-1 lens, a 3-2 lens, a 3-3 lens, and a 3-4 lens, all of which are arranged in order from the object side to the image side along the optical axis;
the 3-3 lens comprises a concave surface facing the image side;
two lenses closest to the image side in the third lens group are meniscus lenses; and
the second lens group comprises a plurality of lenses and adjacent lenses among the lenses have opposite refractive powers.

11. The lens assembly as claimed in claim 10, further comprising a stop disposed between the second lens group and the third lens group and the second lens group can move along the optical axis for focusing.

12. A lens assembly comprising:
a first lens group which is with positive refractive power;
a second lens group which is with negative refractive power; and
a third lens group which is with positive refractive power;
wherein the first lens group, the second lens group, and the third lens group are arranged in order from an object side to an image side along an optical axis;
wherein the lens groups of the lens assembly that are with refractive power are three in number;
wherein a lens closest to the object side in the third lens group is a biconvex lens with positive refractive power and comprises a convex surface facing the object side and another convex surface facing the image side;
wherein two lenses closest to the image side are meniscus lenses in the second lens group;
wherein the second lens group or the third lens group comprises a plurality of lenses and adjacent lenses among the second lens group and the third lens group have opposite refractive powers;
wherein the second lens group comprises a 2-1 lens, a 2-2 lens, and a 2-3 lens;
wherein one of the 2-1 lens, the 2-2 lens, and the 2-3 lens is a biconcave lens and the other two are meniscus lenses;
wherein the 2-1 lens and the 2-3 lens have the same refractive powers and the 2-1 lens and the 2-2 lens have opposite refractive powers;
wherein a lens closest to the object side in the second lens group and a lens closest to the object side in the third lens group have opposite refractive powers.

13. The lens assembly as claimed in claim 12, wherein:
an object side surface shape of a lens closest to the object side in the second lens group is the same as its image side surface shape;
image side surface shapes of adjacent lenses in the first lens group or the second lens group are the same; and
the second lens group and the third lens group comprises a total of five meniscus lenses.

14. The lens assembly as claimed in claim 1, wherein:
the first lens group comprises a 1-1 lens, a 1-2 lens, and a 1-3 lens, all of which are arranged in order from the object side to the image side along the optical axis;
the second lens group comprises a 2-1 lens, a 2-2 lens, and a 2-3 lens, all of which are arranged in order from the object side to the image side along the optical axis;
the 1-2 lens comprises a concave surface facing the image side;
the 2-1 lens comprises a concave surface facing the object side;
the 2-2 lens is a meniscus lens with positive refractive power and comprises a convex surface facing the object side and a concave surface facing the image side; and
the 2-3 lens is a meniscus lens with negative refractive power and comprises a convex surface facing the object side and a concave surface facing the image side.

15. The lens assembly as claimed in claim 14, further comprising a stop disposed between the second lens group and the third lens group and the second lens group can move along the optical axis for focusing.

16. The lens assembly as claimed in claim 14, wherein:
the 1-1 lens is a meniscus lens with negative refractive power and comprises a convex surface facing the object side and a concave surface facing the image side;
the 1-2 lens is a meniscus lens with positive refractive power and further comprises a convex surface facing the object side;
the 1-3 lens is a meniscus lens with positive refractive power and comprises a convex surface facing the object side and a concave surface facing the image side;
the 2-1 lens is a biconcave lens with negative refractive power and further comprises another concave surface facing the image side;
the 3-2 lens is a meniscus lens with negative refractive power and comprises a convex surface facing the object side and a concave surface facing the image side;
the 3-3 lens is a meniscus lens with positive refractive power and further comprises a convex surface facing the object side; and
the 3-4 lens is a meniscus lens with negative refractive power and comprises a concave surface facing the object side and a convex surface facing the image side.

17. The lens assembly as claimed in claim 16, further comprising a stop disposed between the second lens group and the third lens group and the second lens group can move along the optical axis for focusing.

18. The lens assembly as claimed in claim 16, wherein the lens assembly satisfies at least one of following conditions:
$$- 0.76 < fG 2 / f < - 0.6 ;$$
$$0.8 < fG 3 / f < 1.8 ;$$
$$3.6 < β2 < 6 ;$$
$$1.6 < fG 3 / fG 1 < 2.2 ;$$
$$0.75 < TTL / fG 3 < 1.05 ;$$
$$4.5 < TTL / BFL < 8 ;$$
$$0.7 < f / TTL < 0.9 ;$$
$$3.6 < f / BFL < 5.5 ;$$
$$0.4 < T 11 ST / TSTIMA < 0.7 ;$$
$$0.53 < fG 1 / f < 0.82 ;$$
wherein f is an effective focal length of the lens assembly, fG1 is an effective focal length of the first lens group, fG2 is an effective focal length of the second lens group, fG3 is an effective focal length of the third lens group, TTL is an interval from an object side surface of a lens closest to the object side to an image plane along the optical axis, BFL is an interval from an image side surface of a lens closest to the image side to the image plane along the optical axis, T11ST is an interval from the object side surface of the lens closest to the object side to a stop along the optical axis, TSTIMA is an interval from the stop to the image plane along the optical axis, and β2 is a lateral magnification of the second lens group when an object is located at infinity.
